(19) United States
(12) Patent Application Publication
(10) Pub. No.: US 2006/0044468 A1
(43) Pub. Date: Mar. 2, 2006

(54) Single-chip analog to digital video decoder with on-chip vertical blanking interval data slicing during low-power operations

(75) Inventors: Ahsan Chowdhury, Austin, TX (US); James A. Antone, Austin, TX (US); Krishnan Subramoniam, Austin, TX (US)

Correspondence Address: THOMPSON & KNIGHT LLP;Suite 1700, 1700 Pacific Avenue, Dallas, TX, 75201-4693, US

(73) Assignee: Cirrus Logic, Inc., Austin, TX (US)

(21) Appl. No.: 11/041,582

(22) Filed: Jan. 24, 2005

Related U.S. Application Data
(60) Provisional application No. 60/604,439, filed on Aug. 25, 2004.

(51) Int. Cl. H04N 11/00

(52) U.S. Cl. 348/465

(57) ABSTRACT

A single-chip video decoder includes a primary data path for capturing and slicing vertical blanking interval information carried by a primary channel of video data received by a video decoder. Power control circuitry is operable during an inactive period of the video decoder to activate the primary data path during vertical blanking intervals of the received primary channel of video data for capturing and slicing the vertical blanking interval data; and to deactivate the primary data path between the vertical blanking interval and a subsequent vertical blanking interval of the received primary channel of video data to reduce power consumption. According to further inventive concepts, analog and/or digital circuitry which is unnecessary for capturing and slicing the vertical blanking information, including data paths processing secondary channels of video data, is deactivated during substantially the entire inactive period of the video decoder. In an additional embodiment, the input/output ports of the video decoder are set into a static state for substantially the entire inactive period.

### FIELD OF INVENTION

The present invention relates in general to video data processing techniques, and in particular, to a single-chip video decoder with on-chip vertical blanking interval data slicing during low-power operations.

### BACKGROUND OF INVENTION

Three primary video format standards are utilized worldwide to record, transmit and display composite video data, namely, the National Television Systems Committee (NTSC), the Phase Alternating Line (PAL), and the Sequential Couleur avec Memoire (SECAM) standards. In addition, video data may also be recorded, transmitted, and displayed in the red-green-blue (RGB) component video, luminance-chrominance (YPrPb) component video, or S-video formats. In addition to traditional video data, such as luminance (brightness) and chrominance (color) information, these formats also allow other types of information, such as text and programming information, to be encoded into a video signal.

Generally, for interlaced video, each display frame is divided into two fields of a specified number of horizontal lines of pixels per field. A certain number of lines per field, known as the vertical blanking interval (VBI), are reserved for field set-up operations, including returning the display system raster scan to the screen position corresponding to the first pixel in each field. However, not all of the display lines allocated to the VBI are necessary for field set-up purposes, and hence the remaining lines within the VBI are often used for the transmission of data (i.e. VBI data).

The unused lines of the VBI have been commonly used to transmit closed captioning data and text characters (“teletext”). Additionally, VBI extended data services (XLS) allow for the continuous transmission of time and date information that allow a receiving system to automatically reset its time and date settings. Further, the VBI data may also include programming codes associated with video programs being transmitted, such as transmitting station identification, program name, program length, and program start time. A receiving system, such as a video recorder, can thus monitor given video signals, such as those of a standard composite television transmission, and automatically capture a program of interest for recording.

During the time the receiving system is monitoring transmissions for a specific program, those parts of the receiving system that are not necessary for the immediate monitoring tasks are preferably switched into a low power mode. Depending on the user's needs, the period of low power operation may extend from a few minutes to months, or even longer. Throughout this period, any incoming VBI data must be sliced and processed such that when a desired program is about to be broadcast, the receiving system is able to automatically exit the low power mode and begin recording.

Typical video systems, such as digital versatile disk player-recorders, require a full function analog to digital video decoder on one integrated circuit chip for processing traditional video signals and a dedicated VBI slicer on a separate integrated circuit chips for capturing and slicing VBI data. In addition to making the overall system larger and more complex, conventional dedicated VBI slicer chips can often be as expensive as the full function video decoders themselves. However, significant challenges are presented when attempting to integrate a video decoder and a VBI slicer onto a single chip. These challenges must be addressed in order to produce streamlined and less expensive video systems.

### SUMMARY OF INVENTION

The principles of the present invention allow a low-power, full-function, multiple-format analog to digital video decoder to be integrated on a single chip with a VBI slicer. According to one representative embodiment, a single-chip video decoder is disclosed that includes a data path having slicing circuitry for capturing and slicing vertical blanking interval information carried by a channel of video data received by a video decoder. In a low-power operating mode, power control circuitry is operable during an inactive period of the video decoder to activate the primary video channel data path during vertical blanking intervals of the received primary channel of video data for capturing and slicing the vertical blanking interval data; and to deactivate the primary video data path between the vertical blanking interval and a subsequent vertical blanking interval of the received channel of video data to reduce power consumption. In further embodiments, the power control circuitry turns-off the secondary video channel data paths and/or sets the I/O ports into a static state, during the entire period of low power operation.

Embodiments of the present principles advantageously provide for the design and fabrication of an integrated video decoder and VBI slicer onto a single chip. According to these principles, when an integrated video decoder-VBI slicer device is set in a low power or sleep mode, VBI data may still be captured and sliced for output to a host for monitoring wake up events. In particular, those on-chip data paths that are not required for capturing VBI data are de-activated to reduce power consumption. Furthermore, the circuitry which is required for capturing VBI data is only activated when necessary to perform the capture and slicing operations, and then is also set into a low power mode.

### BRIEF DESCRIPTION OF DRAWINGS

For a more complete understanding of the present invention, and the advantages thereof, reference is now made to the following descriptions taken in conjunction with the accompanying drawings, in which:

FIGS. 1A and 1B are high level block diagrams illustrating a representative analog to digital video decoder suitable for describing the principles of the present invention; and

FIG. 2 is a timing diagram illustrating a representative control signal suitable for implementing power reduction features in the analog to digital video decoder of FIGS. 1A and 1B, according to the principles of the present invention.

### DETAILED DESCRIPTION OF THE INVENTION

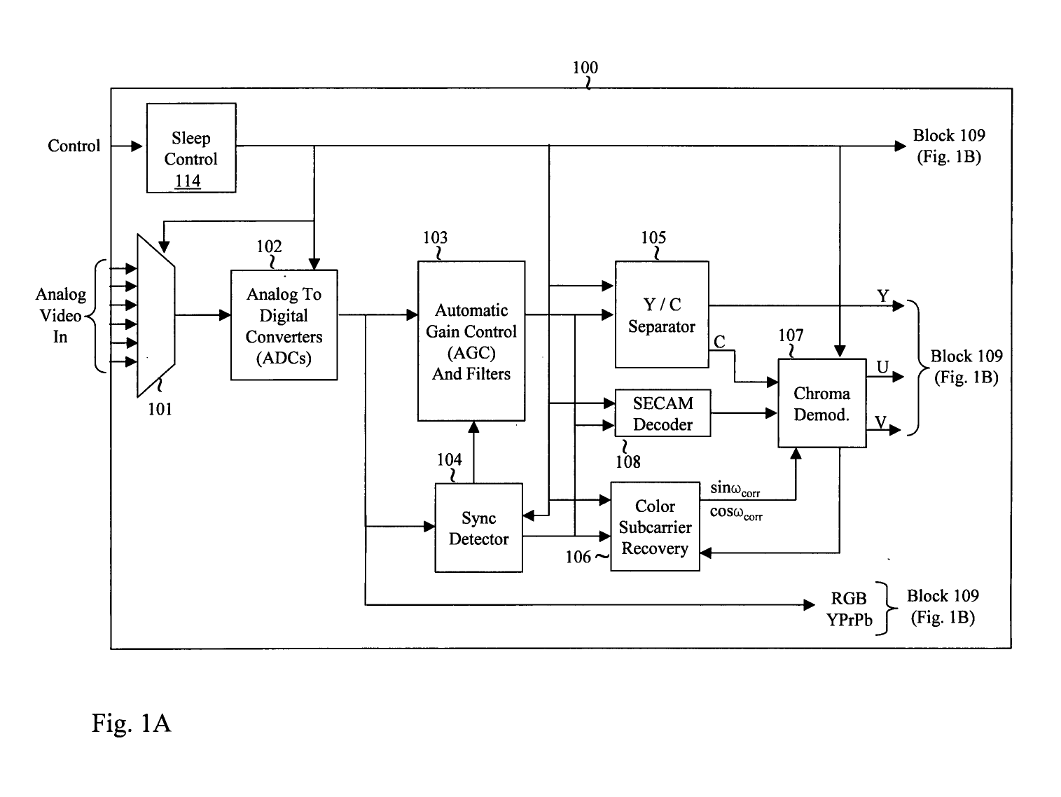

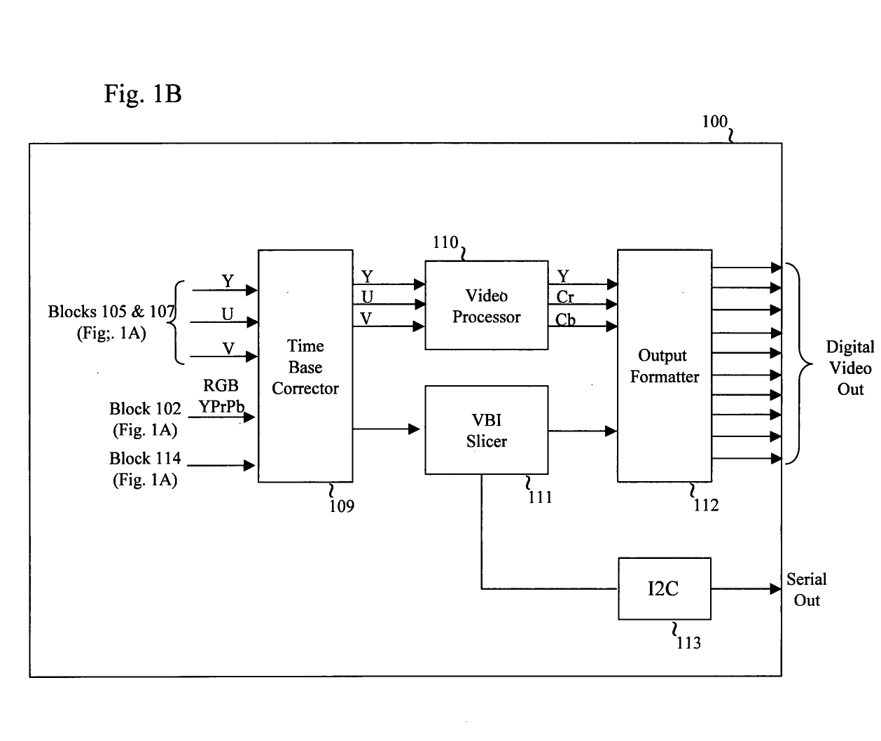

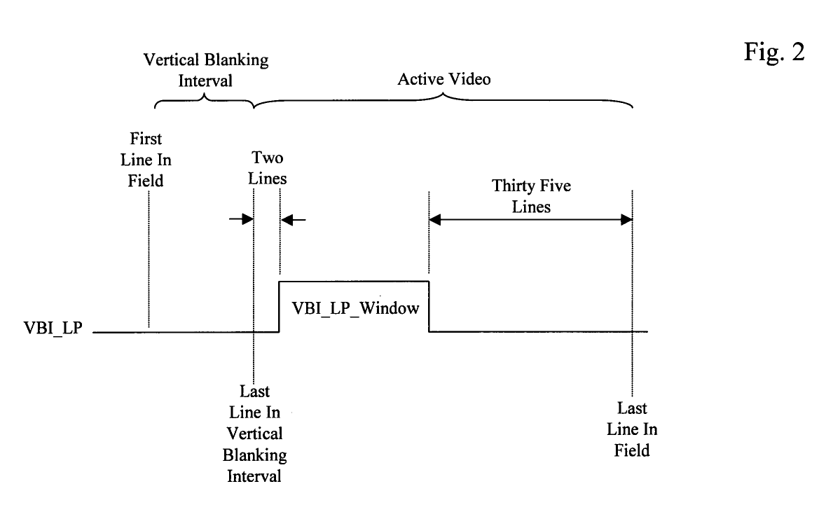

The principles of the present invention and their advantages are best understood by referring to the illustrated embodiment depicted in FIGS. 1-2 of the drawings, in which like numbers designate like parts.

FIGS. 1A-1B are high-level block diagrams of an exemplary analog to digital video decoder 100 suitable for describing the principles of the present invention. A six to four (6:4) input multiplexer 101 provides an interface to an external video source providing analog video data such as composite video, red-green-blue (RGB) component video, SCART-compatible RGB video, S-video or YPrPb component video.

The selected analog input video signals are converted into digital form by analog to digital converters (ADCs) 102. Automatic gain control (AGC) and filters circuit block 103 filters adjusts the levels of the resulting composite digital data streams. Digitized S-video, RGB component video, and YPrPb component video streams, are passed directly to time base corrector 109 of FIG. 1B. Sync detector 104 of FIG. 1A detects the composite video vertical synchronization (VSYNC) signal, which controls the timing of the playback of each display field, and the horizontal synchronization signal (HSYNC), which controls the timing the playback of each display line.

Composite video digital data streams are passed to Y/C separator block 105 and SECAM decoder 108. Y/C separator block 105 separates the luminance (Y) and chrominance (C) components of the digitized composite video data stream. The C component is demodulated into U and V color components by color subcarrier recovery block 106 and chroma demodulation block 107 in response to the phase-error corrected signals sinω_{CORR} and cosω_{CORR}. SECAM decoder 108 decodes those composite video signals received in accordance with the Sequential Couleur avec Memoire (SECAM) standard.

Time base corrector 109 of FIG. 1B receives YUV composite data from Y/C separator 105 and chroma demodulator 107 of FIG. 1A, and/or digitized RGB and YPrPb component video streams from ADCs 102 of FIG. 1A. Time base corrector 109 ensures that a constant number of YUV video data pixels are provided per display line, extracts vertical blanking interval (VBI) data which is sent to vertical blanking interval (VBI) slicer 111, and converts progressive-scan video data streams into interlaced-scan video data streams.

Video processor 110 receives digitized streams of YUV, RGB and/or YPrPb video data from time base corrector 109 and performs color space conversion into the YUV color space. Video processor 110 then performs luminance and chrominance processing on the YUV data to generate a digital video output stream in the YCrCb luminance-chrominance digital video format. An output formatter 112 formats the YCrCb video data into either 10- or 8- bit BT.656 format data, as defined by the International Telecommunications Union (ITU), as the ultimate digital data output of analog to digital video decoder 100.

In contrast to conventional video decoders, analog to digital video decoder 100 advantageously integrates VBI slicer 111 on a single chip. During normal operating modes of analog to digital video decoder 100, VBI slicer 111 formats VBI data extracted by time base corrector 109 into data bytes, which are then packed into the video stream being generated by output formatter 111. In low power operations of analog to digital video decoder 100, as discussed further below, VBI slicer 111 continues to slice received VBI data extracted by time base corrector 109. The sliced data are then transmitted to a host processor through I2C port 113, or similar low-rate serial port, such as an SPI port. The host processor monitors the sliced VBI data, such that triggering events, such as a code associated with a video transmission of interest, may be detected and analog to digital video decoder 100 appropriately reactivated.

For NSTC video, two (2) fields of two hundred sixty three (263) lines each compose one display frame. The lines of the first field are designated lines one (1) through two hundred sixty three (263) and the lines of the second field are designated lines two hundred sixty two (262) through five hundred twenty five (525). In each field, the first twenty two (22) lines are allocated to the VBI (i.e. lines 1-23 for the first field and lines 264-285 for the second field). The remaining lines are allocated to active display generation. In the PAL video system, each field has six hundred twenty five (625) lines partitioned into two (2) fields of three hundred thirteen (313) lines and three hundred twelve (312) lines, respectively. The first twenty three (23) lines of each PAL field are allocated to the VBI.

VBI data are only carried on the primary video channel of the given format. For composite video, VBI data are multiplexed onto the composite signal during the vertical blanking interval. In the RGB component format, VBI data are carried on the green (G) channel, while in the S-video format and YPrPb formats, VBI data are carried on the luma (Y) channel.

According to the principles of the present invention, a single-programmable bit is set in sleep control circuit block 114 of FIG. 1B to set analog to digital video decoder 100 of FIGS. 1A and 1B into a sleep (i.e. low-power) mode. In the sleep mode, the analog data path corresponding to the primary channel of the given data format is dynamically activated and deactivated in order to provide data to VBI slicer 111, while still minimizing power consumption. The analog data paths corresponding to the secondary video channels (i.e. the red and blue channels for RGB data, and the chrominance channels for S-video and YPrPb data) are deactivated for the entire sleep time period. In exemplary analog to digital video decoder 100 of FIG. 1A, the analog path for each primary and secondary video data channel includes the corresponding path through input multiplexer 101 and ADCs 102.

Sync detector 104 remains continuously active in the sleep mode for maintaining a timing lock with the video signal source. The primary channel signal path through and AGC and filters block 103 is dynamically activated and deactivated, as required to provide gain adjustment during VBI data slicing. The secondary signal paths through AGC and filters block 103 are continuously deactivated in the sleep mode.

During sleep, any digital circuitry required for capturing and slicing the VBI data, such as time base corrector 109 and VBI slicer 111, is dynamically activated and deactivated to save power. At the same time, all digital circuitry on analog to digital video decoder 100, which is unnecessary for VBI data capture and slicing, is continuously inactivated in the sleep mode by sleep control circuit block 114. For example, Y/C separator 105, color subcarrier recovery block 106, and video processor 110 are continuously deactivated to save power.

FIG. 2 illustrates the dynamic activation and deactivation of the primary analog data path through multiplexer 101, ADCs 102, and AGC and filter block 103, and the primary digital data path through time base corrector 109 and VBI slicer 111. As shown in FIG. 2, a control signal VB_LP is generated by sleep control circuit block 114, which de-activates the primary channel data path within a time window VB_LP_WINDOW during the generation of each display field. Generally, the primary channel data path is activated during the vertical blanking interval and de-activated during the active video interval of each display line, for either NTSC or PAL systems. In other words, VBI data are extracted by time base corrector 109 and passed to VBI slicer 111 during the vertical blanking period through the primary channel data path, which is then set in sleep mode once the VBI data are captured.

In the illustrated embodiment, a period of two (2) lines is provided between the actual end of the vertical blanking interval and the time the primary channel data path enters the sleep mode. A programmable number of additional lines are provided between the time the primary channel data path is reactivated and the end of the current field, which in the embodiment of FIG. 2 is thirty-five (35) lines. These additional lines allows analog to digital video decoder 100 sufficient time to perform zero-frequency (dc) restoration, and lock onto the source video timing before starting to decode active video lines of the following field. Therefore, while analog to digital video decoder 100 of FIG. 1 is set into the sleep mode, the primary channel data path is inactive for approximately two hundred (200) lines of each field in 535-line video systems, or approximately three hundred (300) lines for each field in 625-line video systems.

When analog to digital video decoder 100 is in the sleep mode, data sliced by VBI slicer are preferably output through 12C port 113 of FIG. 1B. At the same time, output formatter 112 outputs a constant stream of data representing a gray display screen. Advantageously, since the outputs of analog to digital video decoder 100 are not switching, an additional significant reduction in power consumption is realized. The gray display data ensures that if the corresponding display system is left on, the display system continues to generate a constant, but low-level, display screen.

In sum, the principles of the present invention provide integration of VBI slicer circuitry onto the same integrated circuit chip as a full-feature video decoder. According to these principles, when an integrated video decoder and VBI slicer device is set in the a low power or sleep mode, VBI data may still be captured and sliced for output to monitor wake up events. Those data paths not required for capturing VBI data are de-activated to reduce power consumption. Furthermore, the circuitry that is required for capturing and slicing VBI data is only activated when necessary to perform the capture and slicing operations, and then is also set into a low power mode.

In particular, the principles of the present invention provide a number of different techniques for implementing a low power integrated digital video decoder and VBI slicer. For example, during low-power operations of the device, the analog data paths for all secondary video channels are deactivated to save power. Additionally, the analog data path for the primary video channel is only activated as necessary to capture the received VDI data, but is otherwise also deactivated to save further power. Further, all digital circuitry not required for the VBI capture and slicing operations is deactivated during low power operation. Similarly, any digital circuitry utilized for VBI capture and slicing is dynamically deactivated when unneeded. Finally, further power is saved during the low power mode by setting the I/O ports to static state.

Although the invention has been described with reference to specific embodiments, these descriptions are not meant to be construed in a limiting sense. Various modifications of the disclosed embodiments, as well as alternative embodiments of the invention, will become apparent to persons skilled in the art upon reference to the description of the invention. It should be appreciated by those skilled in the art that the conception and the specific embodiment disclosed might be readily utilized as a basis for modifying or designing other structures for carrying out the same purposes of the present invention. It should also be realized by those skilled in the art that such equivalent constructions do not depart from the spirit and scope of the invention as set forth in the appended claims.

It is therefore contemplated that the claims will cover any such modifications or embodiments that fall within the true scope of the invention.

What is claimed is:

1. A method of operating a video decoder comprising:
slicing vertical blanking interval information during an inactive mode of a video decoder, comprising:
activating a primary data path receiving a primary video data channel carrying vertical blanking interval information during a vertical blanking interval; and
deactivating the primary data path between the vertical blanking interval and a subsequent vertical blanking interval to reduce power consumption.

2. The method of claim 1, further comprising deactivating during the inactive mode a secondary data path of the video decoder processing a secondary channel of video data during to reduce power consumption.

3. The method of claim 2, wherein deactivating the secondary data path comprises deactivating an analog data path receiving the secondary channel of video data.

4. The method of claim 1, wherein deactivating the primary data path comprises deactivating analog circuitry of the primary data path between vertical blanking intervals of the video data channel.

5. The method of claim 1, further comprising deactivating selected digital video processing circuitry during the inactive period of the video decoder.

6. The method of claim 1, wherein:
deactivating the primary data path comprises deactivating the data path a selected number of display lines after an end of a current vertical blanking interval; and
reactivating the primary data path comprise reactivating the primary data path a selected number of display lines prior to a start of a subsequent vertical blanking interval.

7. The method of claim 1, further comprising outputting static data from the video decoder during the inactive period for driving an associated display device.

8. The method of claim 7, wherein the static data represents a gray display screen.

9. A single-chip video decoder comprising:
a primary data path including slicing circuitry for capturing and slicing vertical blanking interval information carried by a primary channel of video data received by a video decoder; and
power control circuitry operable during an inactive period of the video decoder to:
activate the primary data path during vertical blanking intervals of the primary channel of video data for capturing and slicing the vertical blanking interval data; and
deactivate the data path between vertical blanking intervals of the received channel of video data to reduce power consumption.

10. The single-chip video decoder of claim 9, wherein the power control circuitry is further operable to deactivate during the inactive period of the video decoder a secondary data path receiving a secondary channel of video data.

11. The single-chip video decoder of claim 9, wherein the primary data path comprises an analog data path for converting the primary channel of video data from analog to digital form.

12. The single-chip video decoder of claim 10, wherein the secondary data path comprises an analog data path for converting a secondary channel of video data from analog to digital form.

13. The single-chip video decoder of claim 9, wherein the power control circuitry is further operable to deactivate selected digital video processing circuitry of the video decoder during the inactive period of the video decoder.

14. The single-chip video decoder of claim 9, further comprising serial output circuitry for outputting sliced vertical blanking interval information during the inactive period.

15. The single-chip video decoder of claim 9, wherein the power control circuitry is operable to deactivate the primary data path a selected number of display lines after an end of a current vertical blanking interval and reactivate the primary data path a selected number of display lines prior to a start of a subsequent vertical blanking interval.

16. The single-chip video decoder of claim 9 further comprising digital output circuitry operable during the inactive period of the video decoder to output static data for driving an associated display device.

17. An integrated circuit comprising:
conversion circuitry including a primary conversion path for converting a primary channel of analog video data into a primary channel of digital video data and a secondary conversion path for converting a secondary channel of analog video data into secondary channel of digital video data;
digital processing circuitry including slicer circuitry for slicing digital vertical blanking interval data of the primary channel of digital data; and
sleep mode control circuitry operable during a sleep mode to deactivate the secondary conversion path and to dynamically activate and deactivate the primary conversion path and the digital processing circuitry to capture vertical blanking interval data received during the sleep mode.

18. The integrated circuit of claim 18, further comprising digital composite video processing circuitry for processing digitized composite video data and wherein the sleep mode control circuitry is further operable to continuously deactivate the digital composite video processing circuitry during the sleep mode.

19. The integrated circuit of claim 18, wherein the primary data channel of analog video data is selected from the group consisting of a composite video signal, a green color component video signal, and a luma signal.
